(19) United States
(12) Patent Application Publication
(10) Pub. No.: US 2026/0053197 A1
(43) Pub. Date: Feb. 26, 2026

(54) AEROSOL GENERATING APPARATUS

(71) Applicant: KT&G CORPORATION, Daejeon (KR)

(72) Inventors: Chul Ho JANG, Gyeonggi-do (KR); Sang Cheol PARK, Gyeonggi-do (KR); Won Kyeong LEE, Gyeonggi-do (KR)

(73) Assignee: KT&G CORPORATION, Daejeon (KR)

(21) Appl. No.: 19/260,785

(22) Filed: Jul. 7, 2025

(30) Foreign Application Priority Data
Aug. 20, 2024 (KR) 10-2024-0111634

(51) Int. Cl. A24F 40/51; G01L 1/16

(52) U.S. Cl. CPC A24F 40/51; G01L 1/16

(57) ABSTRACT

An aerosol generating apparatus includes a cavity housing for providing a cavity in which at least a portion of an aerosol generating article is accommodated, an insertion detection sensor which has at least a portion protruding into the cavity and which is configured to, when the aerosol generating article is inserted into the cavity housing, detect, by using a piezoelectric pressure method, pressure applied by pressing of the protruding portion due to contact with the aerosol generating article, and a controller configured to determine, based on an intensity of the detected pressure, whether the aerosol generating article is inserted into the aerosol generating apparatus.

### CROSS-REFERENCE TO RELATED APPLICATION

This application is based on and claims priority under 35 U.S.C. § 119 to Korean Patent Application No. 10-2024-0111634, filed on Aug. 20, 2024, in the Korean Intellectual Property Office, the disclosure of which is incorporated by reference herein in its entirety.

### BACKGROUND

### 1. Field

The disclosure relates to an aerosol generating apparatus, and more particularly, to a method of determining insertion of an aerosol generating article by using a piezoelectric pressure sensor.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes. Accordingly, research on heating-type aerosol generating devices has been actively conducted.

Meanwhile, as an effort to improve the use convenience for an aerosol generating apparatus, attempts have been made to utilize a function of activating heating of a heater by accurately identifying insertion of an aerosol generating article.

### SUMMARY

Various sensors may be provided in an aerosol generating apparatus, and there has always been a possibility that each of the sensors may malfunction due to environmental conditions, such as temperature or humidity, or sensor fatigue accumulated through frequent use. Sensor malfunction may shorten the lifetime of the aerosol generating apparatus or may cause the aerosol generating apparatus to fail, thereby hindering the safety of use of the aerosol generating apparatus. Especially, various methods have been presented to detect insertion of an aerosol generating article, but a method which is less sensitive to temperature or humidity and is capable of sensing robustly even when droplet deposition occurs due to frequent use is required. The technical objective of the disclosure is not limited to those described above, and other technical objectives may be inferred from embodiments described below.

Additional aspects will be set forth in part in the description which follows and, in part, will be apparent from the description, or may be learned by practice of the presented embodiments of the disclosure.

According to the disclosure, an aerosol generating apparatus detects insertion by using a piezoelectric change method based on pressure physically applied to an insertion detection sensor by insertion of an aerosol generating article, so that an insertion of an aerosol generating article may be accurately detected with less sensitivity to environmental influences and despite the influence of droplet deposition.

According to an embodiment, an aerosol generating apparatus includes a cavity housing for providing a cavity in which at least a portion of an aerosol generating article is accommodated, an insertion detection sensor which has at least a portion protruding into the cavity and which is configured to, when the aerosol generating article is inserted into the cavity housing, detect, by using a piezoelectric pressure method, pressure applied by pressing of the protruding portion due to a contact with the aerosol generating article, and a controller configured to determine, based on intensity of the detected pressure, whether the aerosol generating article is inserted into the aerosol generating apparatus.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 illustrates an aerosol generating device according to an embodiment;

FIG. 3 illustrates an aerosol generating device according to an embodiment;

FIG. 4 illustrates an aerosol generating device according to an embodiment;

FIG. 5 is a diagram for describing a method of detecting insertion of an aerosol generating apparatus into an aerosol generating apparatus, according to an embodiment;

FIG. 6 is a diagram for describing various layouts of an insertion detection sensor within a housing of an aerosol generating apparatus, according to an embodiment;

FIG. 7 is a diagram for describing an insertion detection sensor which detects insertion of an aerosol generating article from a side by using a piezoelectric method, according to an embodiment;

FIG. 8 is a diagram for describing a perspective view and a plan view of a cavity housing in which an insertion detection sensor is arranged, according to an embodiment;

FIG. 9 is a diagram for describing a perspective view and a plan view of a cavity housing in which an insertion detection sensor is arranged, according to another embodiment;

FIG. 10 is a diagram for describing examples of cross-sectional views of a contact module provided in an insertion detection sensor, according to an embodiment;

FIG. 11 is a diagram for describing an insertion detection sensor which detects insertion of an aerosol generating article from a bottom surface (base) by using a piezoelectric method, according to an embodiment;

FIG. 12 is a diagram for describing an insertion detection sensor which detects insertion of an aerosol generating article from a bottom surface by using a piezoelectric method, according to another embodiment;

FIG. 13 is a diagram for describing an insertion detection sensor which detects insertion of an aerosol generating article from a bottom surface by using a piezoelectric method, according to another embodiment;

FIG. 14 is a plan view for describing different examples of a cavity housing in which the insertion detection sensor in FIG. 13 is arranged; and

FIG. 15 is a flowchart of a method of controlling heating of a heater by detecting insertion of an aerosol generating article, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

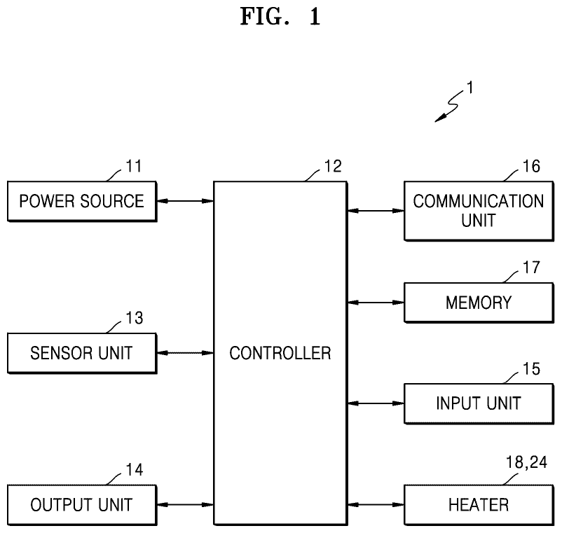

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or heater 18 and 24. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect the heating temperature of the heater 18 and 24 The aerosol generating device 1 may include a separate temperature sensor for detecting respective temperatures of the heater 18 and 24, or the heater 18 and 24 may serve as a temperature sensor. For example, the temperature sensor may be used to measure an impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperatures of the heater 18 and 24. The temperature sensor may output a signal corresponding to the resistance value of the resistive element, and the controller 12 may detect the temperatures and/or temperature changes of the heater 18 and 24, based on the signal corresponding to the resistance value.

As another example, the temperature sensor may include a sensor for detecting the resistance values of the heater 18 and 24. The temperature sensor may output signals corresponding to the resistance values of the heater 18 and 24, and the controller 12 may detect the temperatures and/or temperature changes of the heater 18 and 24, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user′ puff occurs, a temporary temperature drop may occur in the airflow path, a space where an aerosol generating article is inserted (hereinafter, an insertion space), the heater 18 and 24, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused. For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect he authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect he authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18 and 24, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 and 24 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 and 24 may heat a medium and/or an aerosol generating material within the aerosol generating article and/or the cartridge by receiving power from the power supply 11. The aerosol generating device 1 may include a heater 18 for heating the aerosol generating article and/or a cartridge heater 24 for heating the cartridge (i.e., a solid and/or liquid medium).

According to an embodiment, the heater 18 and 24 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 and 24 may be induction heating heaters. For example, the induction heating heaters may include a susceptor that generates heat through a magnetic field. The magnetic field may be generated from an induction coil by an AC current flowing through the induction coil. The generated magnetic field may penetrate a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 and 24 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+ communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18 and 24, thereby controlling the temperatures of the heater 18 and 24. The controller 12 may control the temperatures of the heater 18 and 24 and/or power supplied to the heater 18 and 24, based on the temperatures of the heater 18 and 24 detected using the temperature sensor (e.g., the sensor unit 13). The controller 12 may control the temperatures of the heater 18 and 24 and/or the power supplied to the heater 18 and 24, based on a temperature profile and/or a power profile stored in the memory 17.

According to an embodiment, the controller 12 may control power (e.g., a voltage and/or a current) supplied to the heater 18 and 24 by controlling a power conversion circuit (not shown) electrically connected to the heater 18 and 24 and the power supply 11. For example, the power conversion circuit may include a DC/DC converter (e.g., a buck converter, a buck-boost converter, a boost converter, or a Zener diode) that converts power that is to be supplied to the heater 18 and 24, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 and 24 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18 and 24, by using at least one method among a pulse width modulation (PWM) method and a proportional-integral-differential (PID) method. For example, the controller 12 may control a current pulse having a certain frequency and a duty ratio to be supplied to the heater 18 and 24, by using the PWM method. The controller 12 may control the power supplied to the heater 18 and 24, by adjusting the frequency and duty ratio of the current pulse. For example, the controller 12 may determine a target temperature that is a target of control, based on the temperature profile. The controller 12 may control the power supplied to the heater 18 and 24, by using a PID method, which is a feedback control method using a difference value between the temperatures of the heater 18 and 24 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 and 24 to correspond to preset target power, according to the flow of time.

According to an embodiment, the controller 12 may detect the user's puff by detecting the power supplied to the heater 18 and 24. In more detail, the controller 12 may control the power supplied to the heater 18 and 24, by using the PID method. When the user's puff occurs, a temporary temperature drop may occur in a space where the aerosol generating article is inserted (hereinafter, the insertion space), the heater 18 and 24, etc. Accordingly, a change may occur in the power (or current) supplied to the heater 18 and 24 during power control using the PID method. The controller 12 may detect the user's puff, based on a change in the power that is controlled.

According to an embodiment, the controller 12 may prevent the heater 18 and 24 from being heated. For example, the controller 12 may control an operation of the power conversion circuit so that the amount of the power supplied to the heater 18 and 24 is reduced or the power supply to the heater 18 and 24 is stopped, based on the temperatures of the heater 18 and 24 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18 and 24, based on a result of the sensing performed by the sensor 13.

According to an embodiment, the controller 12 may control supply of power to the heater 18 and 24, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18 and 24. When it is determined using the insertion detection sensor (e.g., the sensor unit 13) that the aerosol generating article has been removed from the insertion space, the controller 12 may block the supply of power to the heater 18 and 24. When the temperatures of the heater 18 and 24 are equal to or greater than a limit temperature or temperature change slopes of the heater 18 and 24 are equal to or greater than a set slope, the controller 12 may determine that the aerosol generating article has been removed from the insertion space.

According to an embodiment, the controller 12 may control power supply time periods and/or power supply amounts for the heater 18 and 24, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18 and 24.

According to an embodiment, the controller 12 may control supply of power to the heater 18 and 24, based on reuse or non-reuse of the aerosol generating article. For example, when it is determined that the aerosol generating article has been used, the controller 12 may block supply of power to the heater 18 and 24.

According to an embodiment, the controller 12 may control supply of power to the heater 18 and 24, based on attachment and/or removal of the cartridge. For example, when it is determined using the cartridge detection sensor (e.g., the sensor unit 13) that the cartridge is in a separated state, the controller 12 may block supply of power to the heater 18 and 24 or may control power to be not supplied to the heater 18 and 24.

According to an embodiment, the controller 12 may control supply of power to the heater 18 and 24, based on whether the aerosol generating material of the cartridge has been exhausted. For example, when it is determined that the temperatures of the heater 18 and 24 exceed the limit temperature while the heater 18 and 24 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18 and 24.

According to an embodiment, the controller 12 may control the supply of power to the heater 18 and 24, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 and 24 are heated is greater than or equal to a preset maximum time period or a total amount of power supplied to the heater 18 and 24 is greater than or equal to a preset maximum power amount, the controller 12 may determine that the use of the cartridge is not possible. In this case, the controller 12 may block supply of power to the heater 18 and 24 or may control power to be not supplied to the heater 18 and 24.

According to an embodiment, the controller 12 may control the supply of power to the heater 18 and 24, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18 and 24. When a puff is sensed, the controller 12 may control the supply of power to the heater 18 and 24.

According to an embodiment, the controller 12 may control supply of power to the heater 18 and 24, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18 and 24. When the aerosol generating article (or the cartridge) is detected as authentic, the controller 12 may control (e.g., start) supply of power to the heater 18 and 24. As another example, the controller 12 may differently control power supply to the heater 18 and 24 according to the types of aerosol generating article (or cartridge). In more detail, when the aerosol generating article (or the cartridge) is detected as a first aerosol generating article (or a first cartridge), the controller 12 may control the temperatures and/or power of the heater 18 and 24, based on a first temperature profile (or a first power profile), and, when the aerosol generating article (or cartridge) is detected as a second aerosol generating article (or a second cartridge), may control the temperatures and/or power of the heater 18 and 24, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18 and 24.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18 and 24, detection of overvoltage application to the heater 18 and 24, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18 and 24, the log data corresponding to the event may include data about, for example, the temperature of the heater 18 and 24, the voltage applied to the heater 18 and 24, and the current flowing through the heater 18 and 24.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater 24 may be included in the cartridge, as a coil-shaped structure that is wound around the liquid delivery unit or in a structure in contact with one side of the liquid delivery unit. Alternatively, the cartridge heater 24 may be included in an aerosol generating device 1 that is separable from the cartridge.

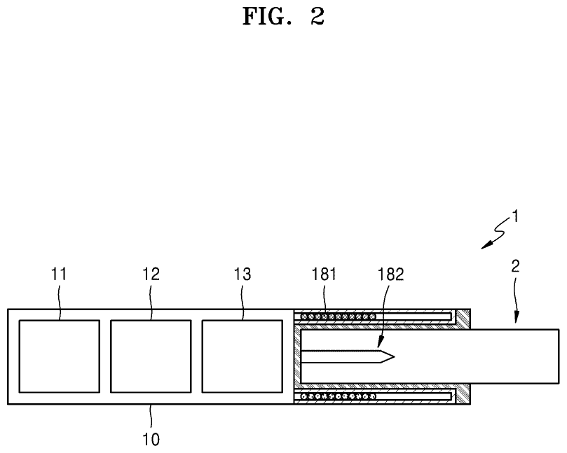

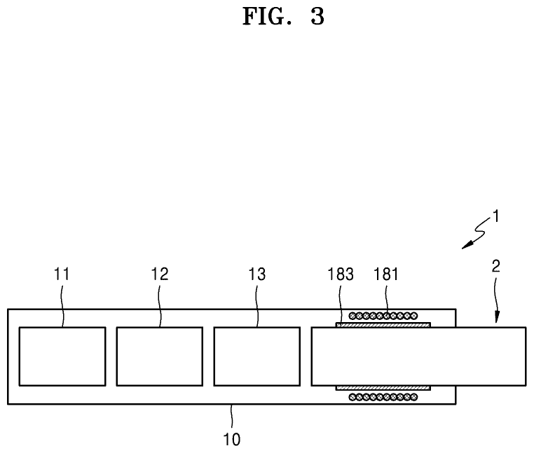

FIG. 2 illustrates an aerosol generating device according to an embodiment. FIG. 3 illustrates an aerosol generating device according to an embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2 or 3. It may be understood by those skilled in the art that some of the components shown in FIG. 2 or 3 may be omitted or new components may be added. The aerosol generating device 1 illustrated in FIG. 2 may be referred to as an ‘internal heating type’ aerosol generating device that heats the inside of an aerosol generating article 2. The aerosol generating device 1 illustrated in FIG. 3 may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2, the heater 182 may be implemented as an internal heating heater.

According to an embodiment, the internal heating heater may extend long upward in a space (i.e., the insertion space) into which the aerosol generating article 2 is inserted. As illustrated in FIG. 2, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

According to an embodiment, the heater 181 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 3, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 3 that overlaps with FIG. 2 will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what shown in FIG. 2 or FIG. 3, the heater 182 of FIG. 2 and the heater 183 of FIG. 3 may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

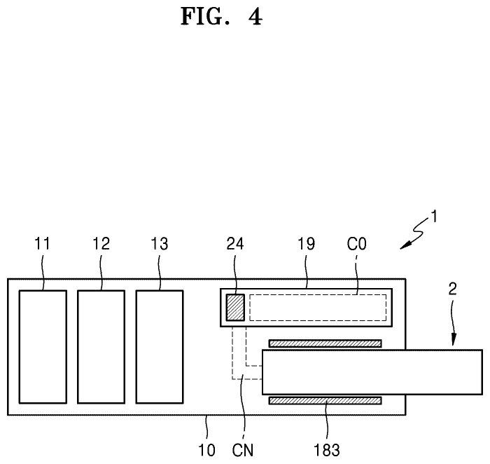

FIG. 4 illustrates an aerosol generating device according to an embodiment.

According to an embodiment, the aerosol generating device 1 may include the housing 10, the power supply 11, the controller 12, the sensor unit 13, and/or the heaters 183 and 24 (e.g., the heater 18 and 24 of FIG. 1). However, the components included in the aerosol generating device 1 are not limited to those shown in FIG. 4. It may be understood by those skilled in the art that some of the components shown in FIG. 4 may be omitted or new components may be added. In the drawings below, any description that overlaps with FIG. 1 will be omitted.

According to an embodiment, the housing 10 may provide a space (hereinafter, an insertion space) opened upward so that the aerosol generating article 2 may be inserted. The insertion space may be recessed toward the inside of the body 10 by a certain depth so that at least a portion of the aerosol generating article 2 may be inserted thereinto. The lower end of the aerosol generating article 2 may be inserted into the housing 10, and the upper end of the aerosol generating article 2 may protrude to the outside of the housing 10.

Unlike the illustration, the cartridge 19 may provide an insertion space for accommodating the aerosol generating article 2. In this case, the insertion space may be recessed toward the inside of the cartridge 19 by a certain depth so that at least a portion of the aerosol generating article 2 may be inserted thereinto. The lower end of the aerosol generating article 2 may be inserted into the cartridge 19, and the upper end of the aerosol generating article 2 may protrude to the outside of the cartridge 19. In this case, the aerosol generating device 1 may not include the heater 183.

According to an embodiment, the depth of the insertion space may be equal to or greater than a length of a region in the aerosol generating article 2, in which an aerosol generating material and/or a medium is included. A user may inhale aerosol by holding, in his or her mouth, the upper end of the aerosol generating article 2 exposed to the outside.

According to an embodiment, the heater 183 may heat the aerosol generating article 2. The heater 183 may extend long upward around the space (i.e., the insertion space) into which the aerosol generating article 2 is inserted. For example, the heater 183 may have a tubular shape (e.g., a cylindrical shape) including a hollow therein. The heater 183 may have a shape including a hollow on the inside and surrounding the hollow. In this case, the heater 183 may be supported by a polyimide film. A heater supported by such a film may be referred to as a film heater. The heater 183 may be arranged to surround at least a portion of the insertion space. The heater 183 may heat the outside of the aerosol generating article 2 inserted into the hollow. In the disclosure, the heater 183 may be referred to as an external heating heater that heats the outside of the aerosol generating article 2. Insulation may also be disposed on the outside of the heater 183. Accordingly, the heat radiated outward by the heater 183 and applied to the outside of the housing 10 may be reduced.

According to an embodiment, the heater 183 may include an electrically resistive heater and/or an induction heating heater.

For example, the electrically resistive heater may include an electrically resistive material, and may be heated as a current flows through the electrically resistive material. In this case, the electrically resistive heater may be electrically connected to the power supply 11, and may generate heat directly by receiving a current from the power supply 11.

For example, in the case of induction heating heaters, the aerosol generating device 1 may include an induction coil (not shown) surrounding at least a portion of the heater 183 (e.g., being disposed outside to correspond to a length of at least a portion of the heater 183). In this case, a magnetic flux concentrator, etc. may be further included on the outside of the induction coil (not shown) in order to increase the efficiency of induction heating. An induction heating heater may include a susceptor, and may generate heat based on a magnetic field generated by the induction coil (not shown).

According to an embodiment, the heater 183 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183. Three or more heaters and/or three or more induction coils may be included.

Unlike the illustration, the aerosol generating device 1 may not include the heater 183. The aerosol generating article 2 may be heated directly or indirectly by the cartridge heater 24, or may not be substantially heated. The indirect heating may mean that the aerosol generating article 2 is heated by receiving heat contained in the aerosol, while the aerosol generated by the cartridge heater 24 is passing through the aerosol generating article 2. In this case, the aerosol generating device 1 may be referred to as a non-heating (or indirect heating) aerosol generating device. The aerosol generating rod of the aerosol generating article 2 may contain additives such as an alkaline substance. Based on the basic material, nicotine included in the aerosol generating rod may have an alkaline pH (e.g., pH 7.0 or higher). This alkaline nicotine may flow into the user's mouth, together with the aerosol flowing from the cartridge 19, which will be described later, into the aerosol generating article 2.

Unlike the illustration, the heater 183 may include an internal heating heater. For example, the internal heating heater may include any of various heating elements, such as a rod-shaped heating element, a tube-shaped heating element, a plate-shaped heating element, or a needle-shaped heating element. The internal heating heater may be inserted through a lower side of the aerosol generating article 2, and may be set to heat the inside of the aerosol generating article 2.

According to an embodiment, the cartridge 19 may be detachably coupled to the housing 10. For example, a space may be formed on one side of the housing 10, and at least a portion of the cartridge 19 may be inserted into the space formed on one side of the body 10, so that the cartridge 19 may be mounted in the housing 10. Alternatively, the cartridge 19 may be integrally formed with the housing 10.

According to an embodiment, the aerosol generating device 1 and/or the cartridge 19 may be provided with an airflow channel through which air flows. For example, the housing 10 may include a structure in which air may be introduced from the outside into the housing 10 while the cartridge 19 is being inserted into the housing 10. The introduced air may pass through the cartridge 19 and be introduced into the insertion space through an airflow channel CN, and may flow into the user's mouth. The airflow channel CN may include various structures for reducing residual droplets or facilitate airflow.

In FIG. 4, the cartridge 19 is shown as being positioned on a lateral side with respect to the aerosol generating article 2, and the airflow channel CN is shown as being formed from a lateral surface of the aerosol generating article 2 to the lower end (i.e., the upstream side) of the aerosol generating article 2. However, the locations of the cartridge 19 and the airflow channel CN are not limited thereto. For example, the cartridge 19 may be located adjacent to the lower end (i.e., the upstream side) of the aerosol generating article 2. In this case, the airflow channel CN may be formed in a substantially straight shape to connect the cartridge 19 to the lower end (i.e., the upstream side) of the aerosol generating article 2.

According to an embodiment, the cartridge 19 may include a storage CO containing an aerosol generating material, the cartridge heater 24, and/or a liquid delivery unit impregnated with (containing) the aerosol generating material. The liquid delivery unit may be impregnated with the aerosol generating material supplied by the storage C0. For example, the liquid delivery unit may include a wick or the like, such as a cotton fiber, a ceramic fiber, a glass fiber, or porous ceramic.

According to an embodiment, the cartridge heater 24 may heat the aerosol generating material included in the cartridge 19. For example, the cartridge heater 24 may include an electrically resistive heater and/or an induction heating heater.

For example, the electrically resistive heater may include an electrically resistive material, and may generate heat as a current flows through the electrically resistive material. As another example, in the case of induction heating heaters, the aerosol generating device 1 may further include an induction coil (not shown) around the induction heating heater. The induction heating heater may include a susceptor, and may generate heat based on a magnetic field generated by the induction coil (not shown). The cartridge heater 24 may be formed in the shape of a coil that surrounds (or is wound around) the liquid delivery unit and/or in a shape (e.g., a pattern shape) in contact with one side of the liquid delivery unit.

Unlike the illustration, the cartridge heater 24 may be included in the aerosol generating device 1. For example, the cartridge heater 24 may be included inside the housing 10. In this case, the cartridge 19 and the cartridge heater 24 may be separated from each other by removing the cartridge 19.

According to an embodiment, aerosol may be generated based on the heat generation of the cartridge heater 24. For example, as the aerosol generating material impregnated in the liquid delivery unit is heated by the cartridge heater 24, vapor may be generated from the aerosol generating material, and, as the generated vapor is mixed with outside air introduced into the cartridge 19, aerosol may be generated. The aerosol generated by the cartridge heater 24 may be introduced into the aerosol generating article 2 through the airflow channel CN. Tobacco or a flavoring agent may be added to the aerosol while the aerosol is passing through the aerosol generating article 2, and the aerosol to which tobacco or a flavoring agent has been added may be inhaled into the user's mouth through one end of the aerosol generating article 2.

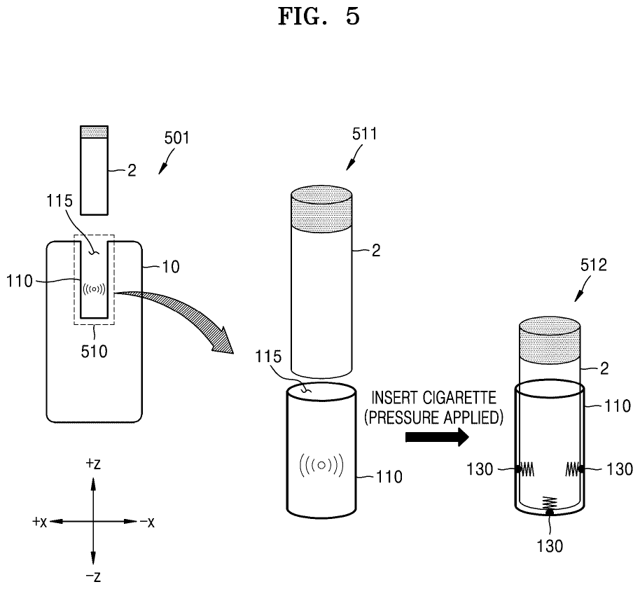

FIG. 5 is a diagram for describing a method of detecting insertion of an aerosol generating apparatus into an aerosol generating apparatus, according to an embodiment.

Referring to reference numeral 501 in FIG. 5, a housing 10 of the aerosol generating apparatus may constitute the overall exterior of the aerosol generating apparatus and may accommodate various elements of the aerosol generating apparatus. A cavity housing 110 may be included in the housing 10 to provide a space for accommodating an aerosol generating article (hereinafter referred to as “cigarette”) 2.

The cavity housing 110 may have a cylindrical or tubular structure that forms a cavity 115, which is an empty space having a certain depth toward the inside the housing 10 so as to accommodate at least a portion of the aerosol generating article 2. The cavity housing 110 may be manufactured as an insulator. The insulator may include a material that is flexible and heat resistant. The insulator may include polyimide or polyetheretherketone (PEEK), but is not limited thereto, and the insulator may include other materials having elasticity, heat resistance, and electrical insulation properties.

When the aerosol generating article 2 corresponds to an article of a normal size, the diameter of the aerosol generating article 2 may be, for example, about 6 mm to about 8 mm, and preferably about 7.2 mm. Unlike the above, when the aerosol generating article 2 corresponds to an article of a slim type, the aerosol generating article 2 may have a relatively less diameter, such as about 3 mm to about 5 mm. The diameter of the cavity housing 110 may be greater than the diameter of the aerosol generating article 2 so that the aerosol generating article 2 may be supported. That is, when the aerosol generating article 2 is inserted into the cavity 115, an gap between the cavity housing 110 and an outer surface of the aerosol generating article 2 may be within about 1 mm. However, the numerical ranges described above are only an example, and those skilled in the art could understand that the numerical ranges may vary depending on the embodiment.

In the embodiment of the aerosol generating apparatus 1 in FIG. 2, the cavity housing 110 may correspond to a thermally conductive structure of an outer wall, which is formed separate from the heater 182 (e.g., an internal heater) and accommodates and surrounds the aerosol generating apparatus 1 being inserted. However, unlike the above, in the embodiment of the aerosol generating apparatus 1 in FIG. 3 or FIG. 4, the heater 183 (e.g., an external heater) has a structure that surrounds a length area (i.e., a heating area) of the aerosol generating article 2. In this case, the cavity housing 110 may correspond to an outer wall structure which is formed outside the heater 183 and supports the aerosol generating article 2 together with the heater 183. That is, although a structure of the cavity housing 110 may vary depending on the heater type, such as an internal heater or an external heater, the cavity housing 110 may refer to the same structure in terms of providing the cavity 115 for accommodating the aerosol generating article 2. Embodiments described below may be applied to all aerosol generating apparatuses having either internal or external heater types without distinction, even when there is no separate description.

As described with reference to FIG. 1, by using an insertion detection sensor 130 provided near the cavity housing 110 or in the cavity housing 110, the aerosol generating apparatus may detect whether the aerosol generating article 2 is inserted or removed.

Reference numerals 511 and 512 in FIG. 5 show an area of reference numeral 501 for the cavity housing 110 in more detail.

Referring to reference numeral 511, a state is shown in which the aerosol generating article 2 is not yet inserted into the cavity 115 of the cavity housing 110. In this case, the insertion detection sensor 130 may be in a state in which no signal change is detected.

Thereafter, as in reference numeral 512, when the aerosol generating article 2 is inserted into the cavity 115 in one direction (e.g., −z direction) along a longitudinal direction of the cavity 115, the insertion detection sensor 130 may detect a change in a signal. For example, when the insertion detection sensor 130 is arranged on a side surface of the cavity 115, the insertion detection sensor 130 may detect pressure in one direction (x direction) which is applied due to insertion of the aerosol generating article 2. Alternatively, when the insertion detection sensor 130 is arranged on a bottom surface (base) of the cavity 115, the insertion detection sensor 130 may detect pressure in one direction (z direction) which is applied due to insertion of the aerosol generating article 2.

However, the insertion detection sensor 130 may be arranged on both the side surface and the bottom surface (base) of the cavity 115, or may be arranged on only either one of the side surface or the bottom surface (base) of the cavity 115. That is, although FIG. 5 shows that the insertion detection sensor 130 is arranged in three areas, this amounts to an example for convenience of description, and a number of areas in which the insertion detection sensor 130 is arranged may vary. For example, the insertion detection sensor 130 may be arranged in one or more areas.

At a location where the insertion detection sensor 130 is arranged, the insertion detection sensor 130 may detect insertion of the aerosol generating article 2 based on contact pressure occurring due to insertion of the aerosol generating article 2. Conversely, the insertion detection sensor 130 may detect removal of the aerosol generating article 2 by detecting the release of contact with the aerosol generating article 2. To this end, the insertion detection sensor 130 may be implemented as a type of piezoelectric sensor which is capable of detecting pressure (pressure value) applied by being pressed by an external physical force. The insertion detection sensor 130 may refer to hardware including a piezoelectric pressure sensor (or also referred to as “a piezoelectric pressure sensing module”) for generating an electric signal corresponding to pressure that has been generated, and detecting an intensity of the pressure.

More specifically, at least a portion of the insertion detection sensor 130 may be arranged in a protruding state on an empty space of the cavity 115. When a force applied from an outer surface of the aerosol generating article 2 to the insertion detection sensor 130 is generated by the insertion of the aerosol generating article 2, the insertion detection sensor 130 may operate in a piezoelectric method where the intensity of the pressure applied onto the protruding portion of the insertion detection sensor 130 into an electric signal. When the insertion detection sensor 130 detects the pressure, the controller (12 in FIG. 1) may determine whether the aerosol generating article 2 is inserted.

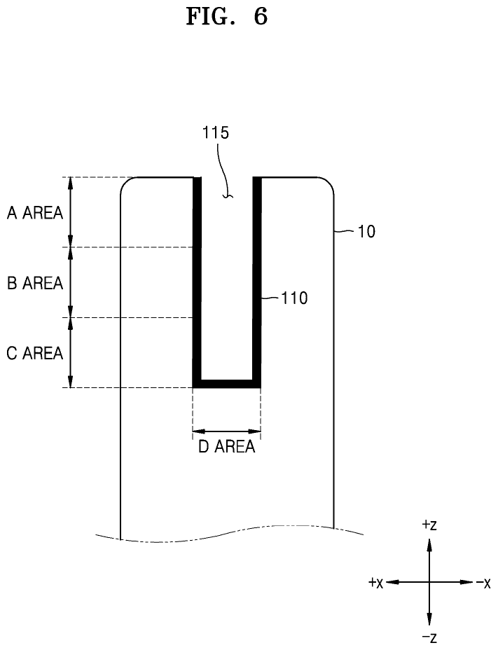

FIG. 6 is a diagram for describing various layouts of an insertion detection sensor within a housing of an aerosol generating apparatus, according to an embodiment.

Referring to FIG. 6, the cavity housing 110 within the housing 10 may be referred and arbitrarily divided into several areas according to the longitudinal direction (z direction) of the cavity 115.

Specifically, a side closest to an opening of the cavity housing 110 is a proximal area and may be referred to as an A area, and a side farthest away from the opening of the cavity housing 110 is a distal area and may be referred to as a C area. In addition, an area near a middle of the cavity housing 110 between the area A and the area C may be referred to as a B area. In addition, a base area of the bottom surface of the cavity housing 110, which is a portion that comes into closest contact with an end of the aerosol generating article 2 when the aerosol generating article 2 is inserted, may be referred to as a D area. However, the areas referred as above are provided as a result of a classification based on an arbitrary distance from the opening of the cavity housing 110, for convenience of description of an embodiment, and the areas may not necessarily be equal in length.

According to the embodiment described above with reference to FIG. 2, the heater 182 of the aerosol generating apparatus 1 may correspond to a type of an internal heater that is inserted into the aerosol generating apparatus 1. In this case, the insertion detection sensor may be arranged in the A area, the B area, or the C area of the cavity housing 110 where the heater 182 is not arranged and thus is not directly heated. However, the D area of the cavity housing 110 may be an area with a relatively high temperature due to a contact with one end of the heater 182, but the insertion detection sensor may be arranged in the D area.

According to the embodiments described above with reference to FIGS. 3 and 4, the heater 183 of the aerosol generating apparatus 1 may correspond to a type of external heater which heats the outer surface of the aerosol generating article 2. When the heater 183 is provided at a height a certain distance from the base on the wall surface of the cavity housing 110, the insertion detection sensor may be arranged in the area A or the area C, which do not overlap the heater 183 on the wall surface of the cavity housing 110. That is, when the area in which the heater 183 is arranged is assumed as the B area, the insertion detection sensor may be arranged in the A area or the C area where the heater 183 is not arranged. Here, based on the longitudinal direction (z direction) of the cavity housing 110, the A, B, and C areas may not be equal in length. Further, when the heater 183 is provided at a height following the B area and the C area from the base on the wall surface of the cavity housing 110, the insertion detection sensor may be arranged in the A area, which does not overlap the heater 183 on the wall surface of the cavity housing 110. Meanwhile, the insertion detection sensor may be arranged in the D area of the cavity housing 110.

That is, it is preferable that the insertion detection sensor is arranged at a location of the cavity housing 110 which does not overlap the heaters 182 and 183, to avoid being directly affected by heating of the heaters 182 and 183. In addition, one or more insertion detection sensors may be arranged in each of the areas.

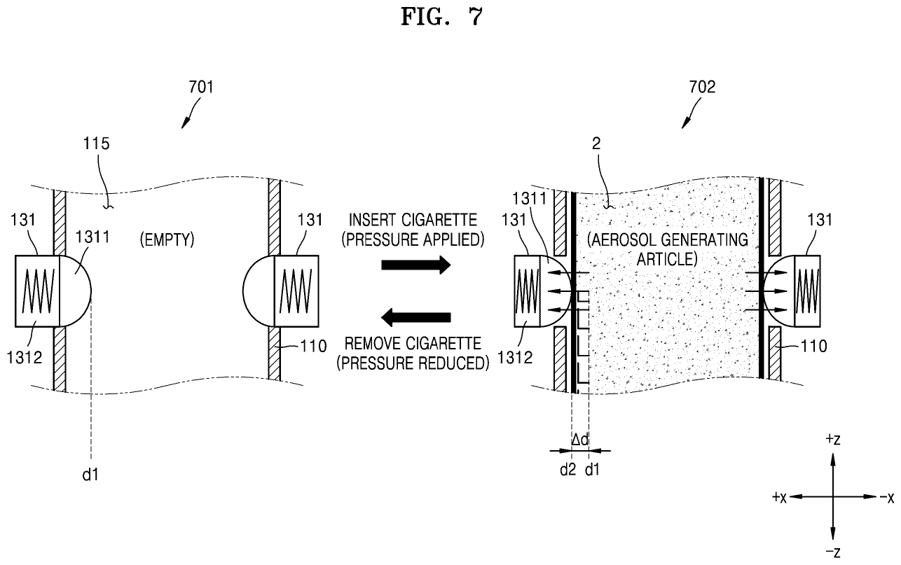

FIG. 7 is a diagram for describing an insertion detection sensor which detects insertion of an aerosol generating article from a side by using a piezoelectric method, according to an embodiment.

Referring to reference numeral 701 in FIG. 7, an insertion detection sensor 131 may be arranged on a side surface of the cavity housing 110. The insertion detection sensor 131 may include a contact module 1311 which causes deformation or displacement following pressure generated in contact with an external object, and a piezoelectric module 1312 which generates an electrical signal based on a pressure change corresponding to the deformation or displacement by the contact module 1311. The piezoelectric module 1312 may convert an intensity of pressure, which is applied to the piezoelectric module 1312 following the contact module 1311 being pressed in the x direction, into an electric signal. That is, the insertion detection sensor 131 may perform piezoelectric pressure sensing. Here, it is described in the present embodiments that the insertion detection sensor 131 includes the contact module 1311 and the piezoelectric module 1312. However, the terms “contact module 1311″ and ”piezoelectric module 1312″ are a result of functional classification, for convenience of description, and the insertion detection sensor 131 may be implemented as a single integrated piezoelectric sensing module.

When no object is present in the cavity 115, the contact module 1311, which corresponds to a portion of the insertion detection sensor 131, may remain in a state of partially protruding toward the cavity 115, and the piezoelectric module 1312 may not detect any pressure.

Meanwhile, a location of the insertion detection sensor 131 in FIG. 7 may correspond to at least one of the A area, the B area, and the C area described with reference to FIG. 6. That is, the location of the insertion detection sensor 131 may be of an option that may be appropriately selected based on the cavity housing 110, depending on the embodiment of the aerosol generating apparatus, and a total of one or more insertion detection sensors 131 may be arranged. When the plurality of insertion detection sensors 131 are arranged, the plurality of insertion detection sensors 131 may not necessarily be arranged in the respective areas, and several insertion detection sensors 131 may be arranged in a single area.

Referring to reference numeral 702 in FIG. 7, the aerosol generating article 2 is shown as being inserted into the cavity 115 of the cavity housing 110. When the aerosol generating article 2 is inserted, the cavity housing 110 may be filled with the cavity 115 due to a volume of the aerosol generating article 2. Accordingly, pressure may be applied to the insertion detection sensor 131 protruding toward the cavity 115.

Specifically, the contact module 1311 of the insertion detection sensor 131 may be pressured in the x direction by the outer surface of the aerosol generating article 2. Accordingly, the piezoelectric module 1312 of the insertion detection sensor 131 may generate an electrical signal based on the pressure change corresponding to the deformation or displacement of the contact module 1311 so that the intensity of the pressure may be measured.

For example, it may be assumed that an initial location of one end of the contact module 1311 before the aerosol generating article 2 is inserted is d1. Thereafter, when the aerosol generating article 2 is inserted, the location of the one end of the contact module 1311 may be changed to d2. That is, the contact module 1311 may be displaced by Δd due to the insertion of the aerosol generating article 2. The piezoelectric module 1312 may convert the intensity of pressure corresponding to the displacement of Δd of the contact module 1311 into an electronic signal so that piezoelectric pressure sensing may be performed on the insertion of the aerosol generating article 2.

The insertion detection sensor 131 may correspond to an element of the sensor unit 13 of the aerosol generating apparatus 1 in FIG. 1 described above. That is, the insertion detection sensor 131 may correspond to an element electrically connected to the controller 12. The pressure change detected by the insertion detection sensor 131 may be transferred to the controller 12, and when the pressure change detected by the insertion detection sensor 131 satisfies a certain condition, the controller 12 may determine that the aerosol generating article 2 is inserted into the aerosol generating apparatus 1.

The controller 12 may determine whether the aerosol generating article 2 is inserted by comparing the intensity of the pressure detected by the insertion detection sensor 131 with preset reference pressure. When the intensity of the pressure detected by the insertion detection sensor 131 exceeds the reference pressure, the controller 12 may determine that the aerosol generating article 2 is inserted. If not, the controller 12 may determine that the aerosol generating article 2 is not inserted.

Meanwhile, after it is determined that the aerosol generating article 2 is inserted, the insertion detection sensor 131 may detect that the pressure intensity is reduced below the reference pressure again. In this case, the controller 12 may determine that the aerosol generating article 2 is removed from the aerosol generating apparatus 1. Here, the removal of the aerosol generating article 2 may refer to a complete removal of the aerosol generating article 2 from the aerosol generating apparatus 1 by a user's intention, or may refer to a state in which the aerosol generating article 2 is slightly detached regardless of a user's intention.

In the present embodiment, the controller 12 determines whether the aerosol generating article 2 is inserted through a comparison between detected pressure and reference pressure. However, various other methods of determining whether the aerosol generating article 2 is inserted, based on the detected pressure, may be employed, and this may be understood to also fall within the scope of the insertion detection method by the controller 12 in the present embodiment.

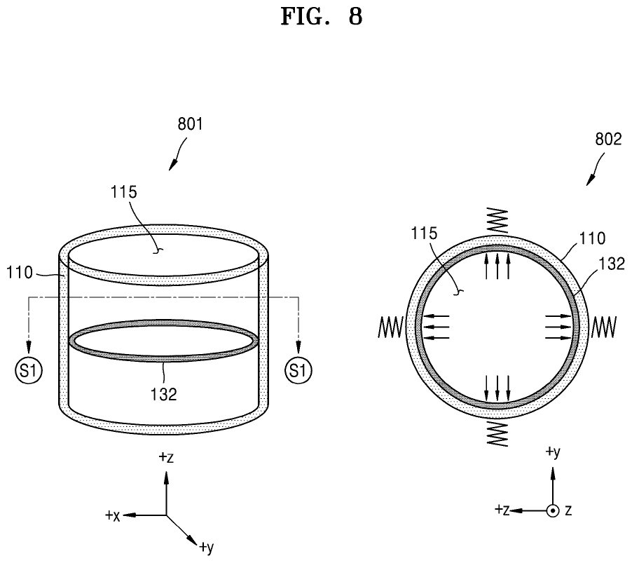

FIG. 8 is a diagram for describing a perspective view and a plan view of a cavity housing in which an insertion detection sensor is arranged, according to an embodiment.

Referring to a perspective view 801 in FIG. 8, an insertion detection sensor 132 may be implemented in a ring shape at a certain side position of the cavity housing 110. That is, the cross-sectional view of the insertion detection sensor 131 described with reference to FIG. 7 may refer to a cross-sectional view of the insertion detection sensor 132 in the ring shape. A portion (i.e., a contact module portion) of the ring-shaped insertion detection sensor 132 may protrude into the cavity 115 and come into contact with the inserted aerosol generating article 2, so that the insertion detection sensor 132 may detect pressure.

A plan view 802 in FIG. 8 is a plan view of S1 direction viewed from above. The ring-shaped insertion detection sensor 132 (e.g., the contact module portion) may partially protrude into the cavity 115 so as to have a less diameter than the cavity housing 110. Accordingly, when the aerosol generating article 2 is inserted into the cavity 115, the ring-shaped insertion detection sensor 132 may detect pressure which is applied radially (i.e., in the x direction) from the outer surface of the aerosol generating article 2.

In FIG. 8, only one ring-shaped sensor is shown. However, the disclosure is not limited thereto, and two or more ring-shaped sensors may be arranged depending on the embodiment.

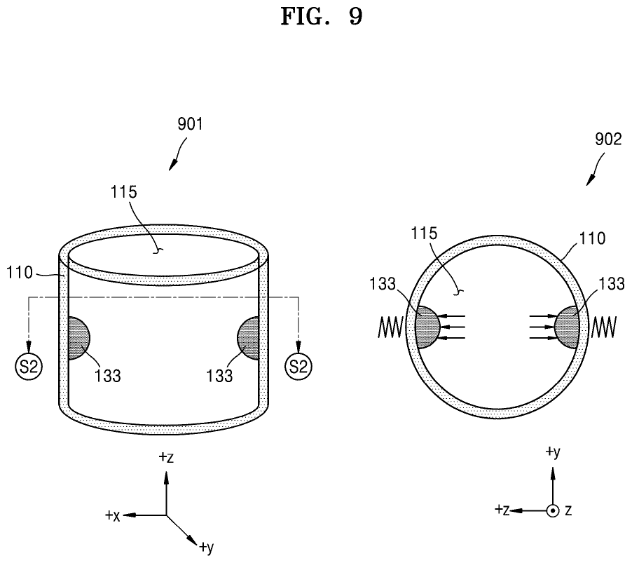

FIG. 9 is a diagram for describing a perspective view and a plan view of a cavity housing in which an insertion detection sensor is arranged, according to another embodiment.

Referring to a perspective view 901 in FIG. 9, insertion detection sensors 133 may be arranged opposite to each other at partial side locations of the cavity housing 110. That is, piezoelectric pressure sensing modules included in the insertion detection sensor 133 may be arranged an appropriate distance apart from each other. A cross-section of the insertion detection sensor 131 described with reference to FIG. 7 may indicate a cross-section of the insertion detection sensors 133 arranged opposite to each other A portion (i.e., a contact module portion) of the insertion detection sensor 133 may protrude into the cavity 115 and come into contact with the inserted aerosol generating article 2, so that the insertion detection sensor 132 may detect pressure.

A plan view 902 in FIG. 9 is a plan view of S2 direction viewed from above. Two insertion detection sensors 133 may be arranged opposite to each other and may partially protrude into the cavity 115. When the aerosol generating article 2 is inserted into the cavity 115, the insertion detection sensor 132 may detect pressure applied radially (i.e., in the x direction) by the outer surface of the aerosol generating article 2.

In FIG. 9, two sensors are provided. However, the disclosure is not limited thereto, and it may be implemented such that only one sensor or three or more sensors are arranged depending on the embodiment. In addition, when a plurality of sensors are arranged, the plurality of sensors are not necessarily arranged at locations that are opposite each other, and may be vertically or horizontally adjacent to each other on a side surface of the cavity housing 110.

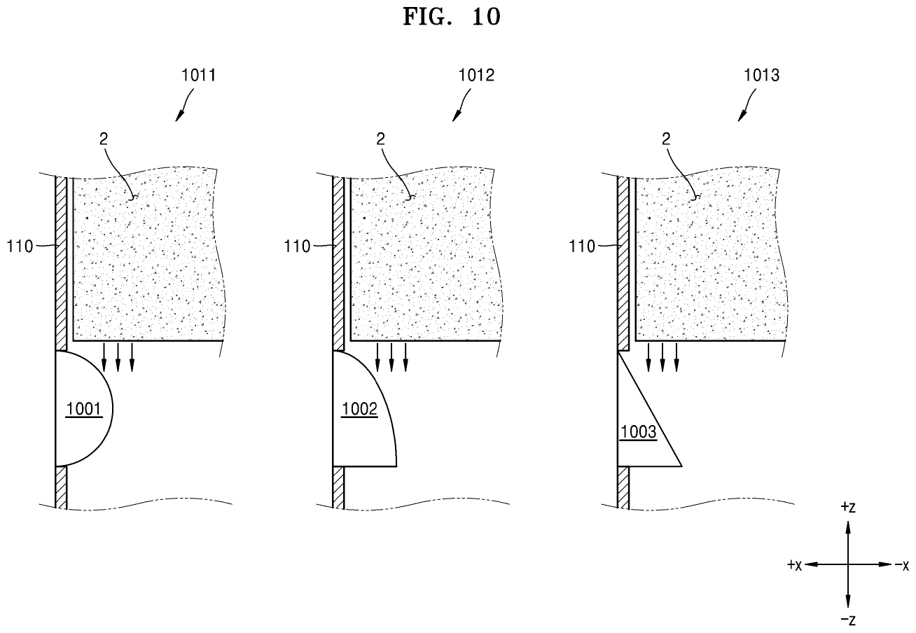

FIG. 10 is a diagram for describing examples of cross-sectional views of a contact module provided in an insertion detection sensor, according to an embodiment.

Referring to FIG. 10, a portion of the insertion detection sensor which is in direct contact with the aerosol generating article 2 in a direction (−z direction) in which the aerosol generating article 2 is inserted may correspond to contact modules 1001, 1002, and 1003. In order to facilitate insertion of the aerosol generating article 2, it is preferable that a portion at which the contact modules 1001, 1002, and 1003 come in initial contact with an end of the aerosol generating article 2 in the insertion process of the aerosol generating article 2 is curved or slidably inclined. Otherwise, the insertion of the aerosol generating article 2 may not be easy when a shape is implemented perpendicular to the longitudinal direction, such as a speed bump.

Referring to a first example 1011, in the insertion detection sensor, a cross-sectional view of the protruding contact module 1001 may be implemented in a curved shape so that the aerosol generating article 2 may slide and apply pressure to the contact module 1001 in a direction (+x direction) perpendicular to the insertion direction.

Similarly, referring to a second example 1012, in the insertion detection sensor, a cross-section of the protruding contact module 1002 may be implemented in a curved shape so that the aerosol generating article 2 may slide and apply pressure to the contact module 1002.

Referring to a third example 1013, in the insertion detection sensor, a cross-section of the contact module 1003 may be implemented in a shape inclined downward (in −z direction). Accordingly, when the aerosol generating article 2 slides, the pressure may be applied to the contact module 1003 in a direction (+x direction) perpendicular to the insertion direction.

In FIG. 10, various embodiments of cross-sectional views of the insertion detection sensor are described. However, the disclosure is not limited thereto, and the insertion detection sensor may be implemented to have a cross-section of a shape which facilitates not only insertion of the aerosol generating article 2 but also measurement of pressure applied by the insertion of the aerosol generating article 2.

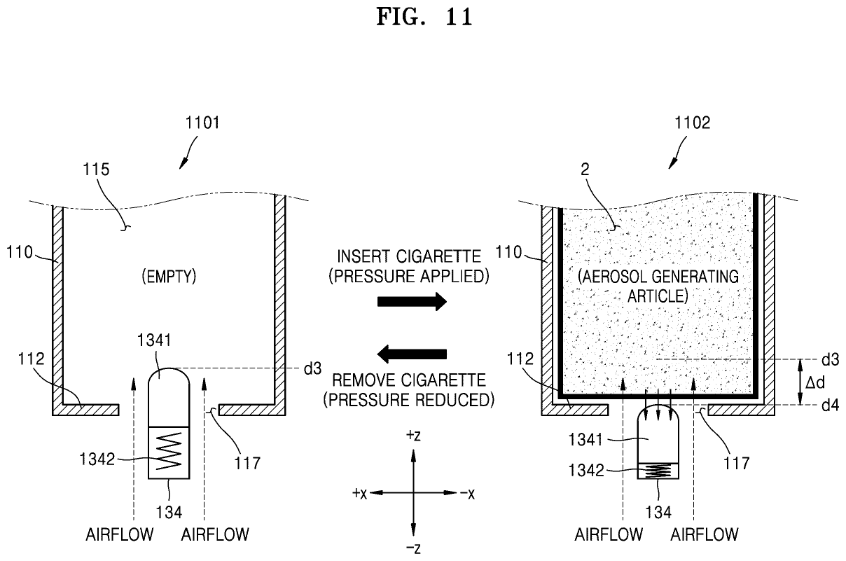

FIG. 11 is a diagram for describing an insertion detection sensor which detects insertion of an aerosol generating article from a bottom surface (base) by using a piezoelectric method, according to an embodiment.

Referring to reference numeral 1101 in FIG. 11, an insertion detection sensor 134 may be arranged on a bottom surface (base) 112 of the cavity housing 110, and the insertion detection sensor 134 may be implemented in a shape protruding onto the cavity 115 (e.g., a bar shape).

The bottom surface 112 may be a base structure which is in contact with the end of the aerosol generating article 2 so that the aerosol generating article 2 is not inserted. The bottom surface 112 may be manufactured by being integrated with a side structure of the cavity housing 110, or may be manufactured as a structure separate from the side structure, and coupled to the structure. The insertion detection sensor 134 may be arranged adjacent to the bottom surface 112. An airflow path (aperture) 117 through which air may flow around the insertion detection sensor 134 may be provided in the bottom surface 112. When a user inhales through the aerosol generating article 2, air introduced into the aerosol generating apparatus from the outside may flow into the aerosol generating article 2 through the airflow path 117 provided in the bottom surface 112 around the insertion detection sensor 134.

The insertion detection sensor 134 may include a contact module 1341 which causes deformation or displacement following pressure applied in one direction (−z direction) by an object, and a piezoelectric module 1342 which generates an electrical signal based on a pressure change corresponding to the deformation or displacement by the contact module 1341. That is, the piezoelectric module 1342 may convert an intensity of pressure, which is applied to the piezoelectric module 1312 following the contact module 1341 being pressed in the −z direction, into an electric signal. However, as described above, the insertion detection sensor 134 may be implemented as a single integrated piezoelectric sensing module rather than being divided into the contact module 1341 and the piezoelectric module 1342.

As shown by reference numeral 1101, when no object is present in the cavity 115, the contact module 1341, which corresponds to a portion of the insertion detection sensor 134, may retain a state of partially protruding toward the cavity 115, and the piezoelectric module 1342 may not detect any pressure.

Referring to reference numeral 1102 in FIG. 11, the aerosol generating article 2 is shown as being inserted into the cavity 115 of the cavity housing 110. Contact pressure by the end of the aerosol generating article 2 may be applied to the insertion detection sensor 134 protruding toward the cavity 115. Accordingly, a location of one end of the contact module 1341 may be changed from d3 to d4. The contact module 1341 may be displaced by Δd due to the insertion of the aerosol generating article 2. The piezoelectric module 1342 may convert the intensity of pressure corresponding to the displacement of Δd of the contact module 1341 into an electronic signal so that piezoelectric pressure sensing may be performed on the insertion of the aerosol generating article 2.

The location of the insertion detection sensor 134 in FIG. 11 may correspond to the D area described with reference to FIG. 6. For example, in the embodiments of the aerosol generating apparatus 1 including the heater 183, in FIGS. 3 and 4, the insertion detection sensor 134 may be arranged in the D area. However, even in the embodiments of FIGS. 3 and 4, the insertion detection sensor 134 is not necessarily arranged in the D area and may be arranged in other areas (any of the A area to the C area).

Although FIG. 11 shows only one insertion detection sensor 134, but two or more sensors may be arranged on the bottom surface 112, depending on the embodiment.

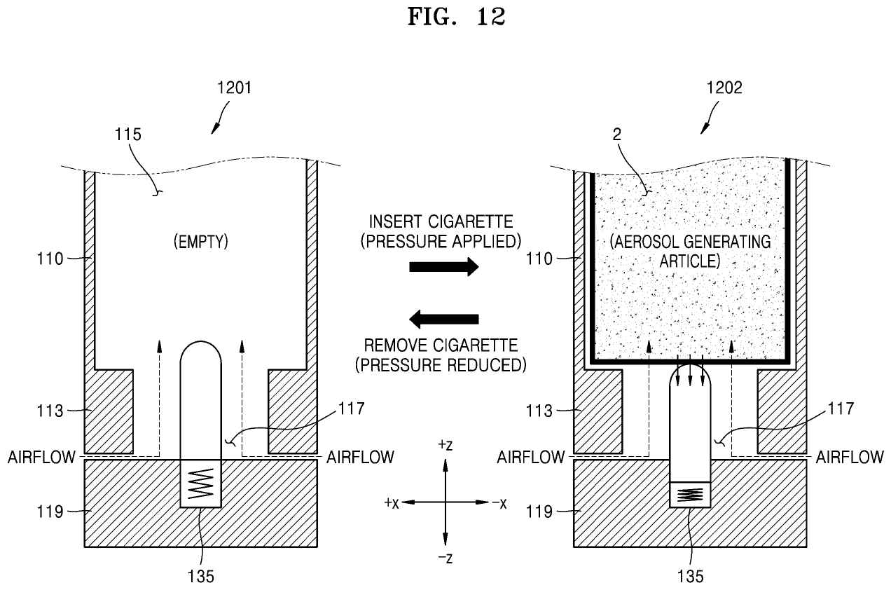

FIG. 12 is a diagram for describing an insertion detection sensor which detects insertion of an aerosol generating article from a bottom surface by using a piezoelectric method, according to another embodiment.

Referring to reference numerals 1201 and 1202 in FIG. 12, compared to FIG. 11, a separate spacer structure (or stopper structure) 113 may be coupled to a lower end of the cavity housing 110 instead of the bottom surface 112. That is, the spacer structure (or stopper structure) 113 may correspond to a base structure. The space structure 113 may correspond to a base structure which is in contact with the end of the aerosol generating article 2 so that the aerosol generating article 2 is not inserted. An insertion detection sensor 135 may be arranged adjacent to the space structure 113. Through an empty space (aperture) in the space structure 113, the insertion detection sensor 135 may be implemented to be longer than a height of the space structure 113 and to protrude into the cavity 115.

The insertion detection sensor 135 may be embedded in a flange 119. Depending on the embodiment, external air introduced between the space structure 113 and the flange 119 may be provided into the aerosol generating article 2 through the airflow path (aperture) 117 formed in the space structure 113. That is, the airflow path (aperture) 117 may be formed around the insertion detection sensor 135 provided in the empty space of the space structure 113.

The embodiment of FIG. 12 differs from the embodiment of FIG. 11 only in the lower structure of the cavity housing 110, but a method of piezoelectric pressure sensing is the same.

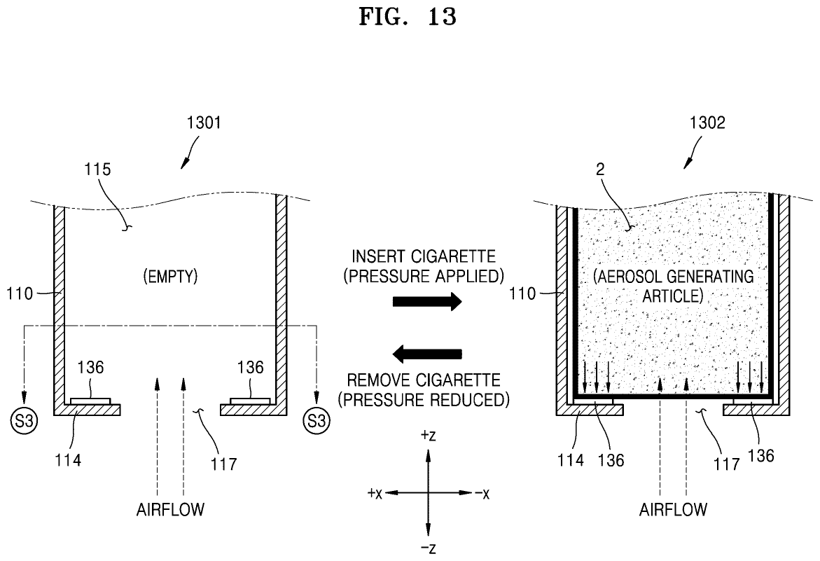

FIG. 13 is a diagram for describing an insertion detection sensor which detects insertion of an aerosol generating article from a bottom surface by using a piezoelectric method, according to another embodiment.

Referring to reference numerals 1301 and 1302 in FIG. 13, compared to FIGS. 11 and 12, an insertion detection sensor 136 may be implemented as a flat-type piezoelectric pressure sensor.

The insertion detection sensor 136 may be arranged adhered to a bottom surface (base) 114 of the cavity housing 110. When the aerosol generating article 2 is inserted and approaches close to the bottom surface 114, the end of the aerosol generating article 2 may apply pressing force to the flat-type piezoelectric pressure sensor (the insertion detection sensor 136). The flat-type piezoelectric pressure sensor (the insertion detection sensor 136) may perform piezoelectric sensing to convert, into an electric signal, an intensity of pressure applied in a single direction (−z direction) by the aerosol generating article 2, thereby detecting insertion of the aerosol generating article 2.

Meanwhile, the airflow path (aperture) 117 through which external air flows into the aerosol generating article 2 may be provided in the bottom surface 112.

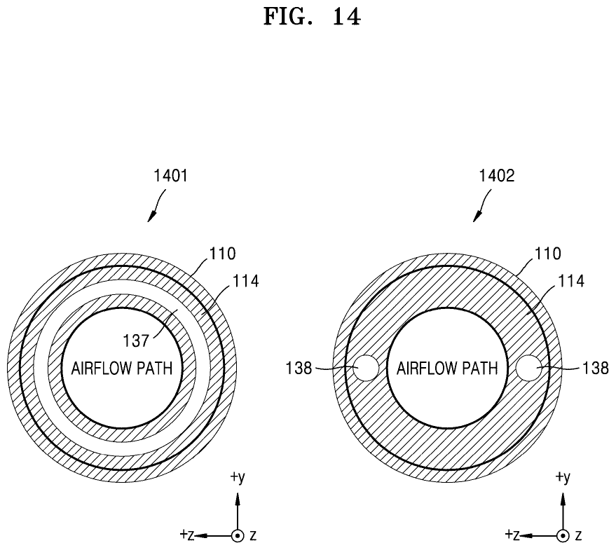

FIG. 14 is a plan view for describing different examples of a cavity housing in which the insertion detection sensor in FIG. 13 is arranged.

Referring to reference numeral 1401 in FIG. 14, an insertion detection sensor 137 may be arranged on the bottom surface (base) 114 of the cavity housing 110, and the insertion detection sensor 137 may be implemented as a flat-type piezoelectric pressure sensor (piezoelectric pressure sensing module) having a circular shape. That is, the insertion detection sensor 137 may be arranged in a shape which surrounds an opening (aperture) for an airflow path formed in the bottom surface 114.

The insertion detection sensor 137 may perform piezoelectric sensing to convert, into an electric signal, the pressure applied in a single direction (−z direction) by an end of the aerosol generating article 2, thereby detecting insertion of the aerosol generating article 2.

Referring to reference numeral 1402 in FIG. 14, unlike in reference numeral 1401, an insertion detection sensor 138 may correspond to a flat-type piezoelectric pressure sensor manufactured in small module units. For example, in reference numeral 1402, the insertion detection sensors 138 of two modules are arranged. However, the disclosure is not limited thereto, and the number of insertion detection sensors 138 may also be one or more than two. In addition, it is merely preferable that the insertion detection sensor 138 is arranged at a location where contact pressure by the aerosol generating article 2 may be detected on the bottom surface 114. Thus, the location of the insertion detection sensor 138 on the bottom surface 114 may vary.

In the embodiments of the drawings described above, various embodiments are described in which insertion of an aerosol generating article is detected by using an insertion detection sensor of a piezoelectric pressure sensing method.

However, a plurality of piezoelectric pressure sensing modules may be arranged at various different locations. In this case, when it is determined that the intensity of pressure which is a certain size or more is detected from at least two piezoelectric pressure sensing modules from among the plurality of piezoelectric pressure sensing modules, the controller 12 may determine that the aerosol generating article 2 is inserted. Alternatively, even when a plurality of piezoelectric pressure sensing modules are arranged, the controller 12 may determine that the aerosol generating article 2 is inserted, when pressure is detected by a module. That is, the insertion detection method may not be limited to any single embodiment.

Further, the controller 12 of the aerosol generating apparatus 1 may control the aerosol generating apparatus 1 by linking a function of detecting insertion of the aerosol generating article 2 with other functions, thereby providing more extended operations of the aerosol generating apparatus 1.

For example, when insertion of the aerosol generating article 2 is detected, the controller 12 may control execution of a function of initiating heating by a heater so that an aerosol is generated from the inserted aerosol generating article 2. In addition, when the insertion of the aerosol generating article 2 is detected, the controller 12 may control execution of additional sensing functions for identifying which type (flavor, material, humidity, or the like) the aerosol generating article 2 corresponds to. Further, when the insertion of the aerosol generating article 2 is detected, the controller 12 may control execution of various user interface (UI) functions for indicating that the aerosol generating article 2 has been inserted. Below, a process is described in detail in which heating by a heater is initiated through insertion detection of the aerosol generating article 2.

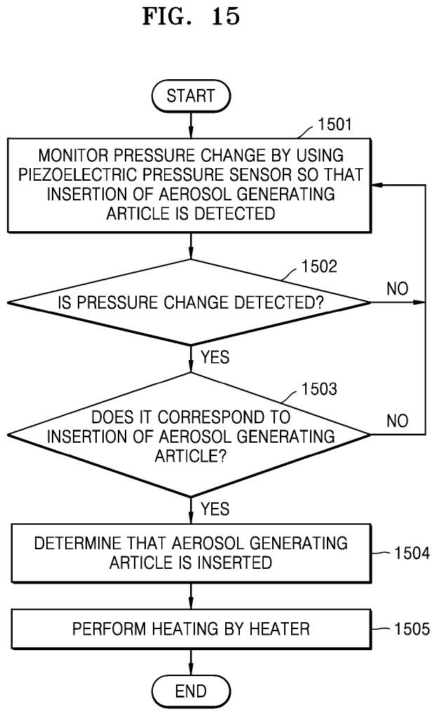

FIG. 15 is a flowchart of a method of controlling heating of a heater by detecting insertion of an aerosol generating article, according to an embodiment.

Referring to FIG. 15, a method of controlling heating of a heater through insertion detection corresponds to operations in time series in the aerosol generating apparatus 1 described above with reference to the drawings. Accordingly, even when omitted below, the descriptions provided above with reference to the drawings may also be applied to the control method of FIG. 15.

In operation 1501, the insertion detection sensor 130 provided in the sensor unit 13 of the aerosol generating apparatus 1 may monitor a pressure change by using a piezoelectric pressure sensor so that an insertion of the aerosol generating article 2 into the aerosol generating apparatus 1 may be detected. The insertion detection using a piezoelectric pressure sensor may also be performed by using the methods described with reference to FIGS. 5 to 14.

In operation 1502, the controller 12 of the aerosol generating apparatus 1 may determine whether a pressure change is detected by the piezoelectric pressure sensor of the insertion detection sensor 130. When a pressure change is detected, the controller 12 may perform operation 1503. In contrast, when no pressure change is detected, the controller 12 may control the insertion detection sensor 130 to keep monitoring.

In operation 1503, when a pressure change is detected by the piezoelectric pressure sensor of the insertion detection sensor 130, the controller 12 may determine whether the pressure change corresponds to an insertion of an aerosol generating article, based on an electric signal corresponding to the detected pressure change.

The controller 12 may determine whether the aerosol generating article 2 is inserted into the aerosol generating apparatus 1 based on whether the detected pressure change satisfies a certain condition. For example, the controller 12 may determine whether the aerosol generating article 2 is inserted by comparing the detected pressure change with preset reference pressure. When an intensity of the detected pressure exceeds the reference pressure, the controller 12 may perform operation 1504. Otherwise, the controller 12 may control the insertion detection sensor 130 to keep monitoring.

In operation 1504, the controller 12 may determine that the aerosol generating article 2 is inserted, based on the intensity of the pressure detected in operation 1503 exceeds the reference pressure.

In operation 1505, when the aerosol generating article 2 is inserted, the controller 12 may heat heaters 18 and 24 so that an aerosol is generated from the aerosol generating article 2.

That is, the aerosol generating apparatus 1 according to the present embodiment may monitor whether the aerosol generating article 2 is inserted into the aerosol generating apparatus 1, and when the aerosol generating article 2 is inserted, automatically initiate heating of the aerosol generating article 2.

Certain embodiments or other embodiments of the disclosure described above are not exclusive or distinct from each other. The certain embodiments or other embodiments of the disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictively and should be considered illustrative, in all aspects. The scope of the disclosure should be determined by a rational interpretation of the attached claims, and all changes within the equivalent scope of the disclosure are included in the scope of the disclosure.

According to the embodiments described above, an insertion may be detected based on pressure physically applied to an insertion detection sensor by insertion of an aerosol generating article, so that an insertion of an aerosol generating article may be accurately detected with less sensitivity to environmental influences and despite the influence of droplet deposition due to frequent use. Furthermore, heating by a heater may be immediately initiated by insertion of an aerosol generating article by linking a function of insertion detection with a heating function of the heater, so that smoking may be started without the user having to perform many cumbersome operations, thereby improving user convenience.

What is claimed is:

1. An aerosol generating apparatus comprising:
a cavity housing for providing a cavity in which at least a portion of an aerosol generating article is accommodated;
an insertion detection sensor which has at least a portion protruding into the cavity and which is configured to, when the aerosol generating article is inserted into the cavity housing, detect, by using a piezoelectric pressure method, pressure applied by pressing of the protruding portion due to contact with the aerosol generating article; and
a controller configured to determine, based on intensity of the detected pressure, whether the aerosol generating article is inserted into the aerosol generating apparatus.

2. The aerosol generating apparatus of claim 1, wherein the insertion detection sensor includes at least one piezoelectric pressure sensing module arranged adjacent to at least one location from among a side surface and a bottom surface of the cavity housing.

3. The aerosol generating apparatus of claim 1, wherein the insertion detection sensor includes a plurality of piezoelectric pressure sensing modules arranged at different locations, and
the controller is further configured to, when it is determined that an intensity of pressure of a certain size or more is detected from at least two piezoelectric pressure sensing modules from among the plurality of piezoelectric pressure sensing modules, determine that the aerosol generating article is inserted into the aerosol generating apparatus.

4. The aerosol generating apparatus of claim 1, wherein the insertion detection sensor is arranged on a side surface of the cavity housing, and
is configured to detect pressure applied in a radial direction due to insertion of the aerosol generating article, the radial direction being perpendicular to an insertion detection.

5. The aerosol generating apparatus of claim 4, wherein the insertion detection sensor includes a ring-shaped piezoelectric pressure sensing module which surrounds the side surface of the cavity housing, and
the ring-shaped piezoelectric pressure sensing module
has a diameter less than a diameter of the cavity housing such that at least a portion of the ring-shaped piezoelectric pressure sensing module protrudes into the cavity.

6. The aerosol generating apparatus of claim 4, wherein the insertion detection sensor includes at least two piezoelectric pressure sensing modules arranged opposite to each other on the side surface of the cavity housing.

7. The aerosol generating apparatus of claim 1, wherein the insertion detection sensor includes a bar-shaped piezoelectric pressure sensing module which has at least a portion protruding into the cavity housing and which is arranged adjacent to a bottom surface of the cavity housing or a spacer structure coupled to the cavity housing, and
the bar-shaped piezoelectric pressure sensing module is configured to detect pressure applied in an insertion direction due to insertion of the aerosol generating article.

8. The aerosol generating apparatus of claim 7, wherein the bottom surface or the spacer structure has an opening around a periphery of the bar-shaped piezoelectric pressure sensing module to provide an airflow path through which external air flows into the aerosol generating article.

9. The aerosol generating apparatus of claim 1, wherein the insertion detection sensor includes a flat-type piezoelectric pressure sensing module provided on a bottom surface of the cavity housing or a spacer structure coupled to the cavity housing, and
the flat-type piezoelectric pressure sensing module is configured to detect pressure applied in an insertion direction due to insertion of the aerosol generating article.

10. The aerosol generating apparatus of claim 1, wherein the cavity housing is divided, based on an insertion direction of the aerosol generating article, into a proximal area close to an opening of the cavity housing, a distal area far from the opening of the cavity housing, and an intermediate area between the proximal area and the distal area, and
the insertion detection sensor is arranged in at least one area from among the proximal area, the distal area and the intermediate area, based on a type of a heater provided in the aerosol generating apparatus.

11. The aerosol generating apparatus of claim 10, wherein the insertion detection sensor is arranged in at least one area which is not directly heated by the heater from among a base area, the proximal area, the distal area and the intermediate area of the cavity housing.

12. The aerosol generating apparatus of claim 1, wherein the controller is further configured to, when it is determined that the aerosol generating article is inserted, control the heater to initiate heating of the aerosol generating article.

13. The aerosol generating apparatus of claim 1, wherein the controller is further configured to:
compare an intensity of the pressure detected by the insertion detection sensor with a reference pressure; and
when it is determined that the intensity of the detected pressure exceeds the reference pressure, determine that the aerosol generating article is inserted.

14. The aerosol generating apparatus of claim 1, wherein the controller is further configured to control a heater to initiate heating of the aerosol generating article when it is determined that the aerosol generating article is inserted into the cavity housing.
